(19) United States
(12) Patent Application Publication
(10) Pub. No.: US 2014/0075280 A1
(43) Pub. Date: Mar. 13, 2014

(54) Systems and Methods for Transferring Data from an Accessible Database into Forms that Manipulate Databases

(71) Applicant: SW DEVELOPMENT, LLC, Bend, OR (US)

(72) Inventors: Andrew Laakmann, Bend, OR (US); Mark Silliman, Bend, OR (US)

(73) Assignee: SW Development, LLC, Bend, OR (US)

(21) Appl. No.: 13/830,155

(22) Filed: Mar. 14, 2013

Related U.S. Application Data
(60) Provisional application No. 61/700,858, filed on Sep. 13, 2012.

(51) Int. Cl. G06F 17/24

(52) U.S. Cl. CPC G06F 17/243
USPC 715/225

(57) ABSTRACT

Aspects of the present invention comprise systems and methods for facilitating transfers of data between an accessible data store and one that may not be directly accessible. In embodiments, an application interfaces with a web form of a client system to facilitate data transfer with an accessible database at a service provider system. The data transfer occurs even where the application may not have access to modify directly the destination database. By using web form filling, the systems and methods presented herein can dynamically determine mappings between fields in the client forms and fields in the service provider records and thereby service a variety of client records systems. Embodiments of the present invention also include capturing of one or more images triggered by event interactions with the form; and, in embodiments, one or more captured images may be combined with the form as evidence of who completed the form.

### CROSS-REFERENCE TO RELATED APPLICATION

This application claims the priority benefit under 35 USC §119(e) to commonly assigned and co-pending U.S. Patent Application No. 61/700,858 (Attorney Docket No. 20104-1736P), filed on 13 Sep. 2012, entitled “Systems and Methods for Transferring Data from an Accessible database into Forms that Manipulate Databases,” listing as inventors Andrew Laakmann and Mark Silliman. The above-mentioned patent document is incorporated by reference herein in its entirety.

### COPYRIGHT NOTICE

A portion of this patent document contains material which is subject to copyright protection. To the extent required by law, the copyright owner has no objection to the facsimile reproduction of the document, as it appears in the U.S. Patent and Trademark Office patent file or records, but otherwise reserves all copyright rights whatsoever.

### BACKGROUND

A. Technical Field

The present invention pertains generally to computer applications, and relates more particularly to systems and methods for transferring data between different databases.

B. Background of the Invention

When an entity, for example a business, receives information from another party, such as one of its customers, the entity often maintains that data in a database of a point-of-sale (POS) system or a customer-record-management (CRM) system. In some situations, the data for a customer may be contained in one system but may preferably be needed in another system. Such instances can occur when different systems are used within the same organization, when transitioning to new systems, or when dealing with associated businesses or services.

For example, a company's sales system may be maintained by the company and its system contains records of customers that it has interacted with directly. The company, may also partner with another business to provide a related service. The related service business may maintain its own database of customer records. A customer that first interacts with the related service business may supply its information to that business but not to the company. The company would also like to have that customer's information and maintain it in its own database. However, the manual data entry or data transfer between the two unrelated databases can be a time consuming, costly, or otherwise burdensome endeavor.

Accordingly, what is needed are systems and methods that better facilitate the transfer of data between records systems.

### BRIEF DESCRIPTION OF THE DRAWINGS

Reference will be made to embodiments of the invention, examples of which may be illustrated in the accompanying figures. These figures are intended to be illustrative, not limiting. Also, although the invention is generally described in the context of these embodiments, it should be understood that it is not intended to limit the scope of the invention to these particular embodiments.

FIG. 1 depicts a typical environment in which aspects of the present invention may operate according to embodiments of the present invention.

FIG. 2 depicts a method by which a form is completed according to embodiments of the present invention.

FIG. 3 depicts a method by which one or more images are captured during the process of completing a form according to embodiments of the present invention.

FIG. 4 depicts a method in which the image capture request process is checked for completion prior to submitting form data to a service provider system according to embodiments of the present invention.

FIG. 5 depicts a method for combining one or more captured images of a person completing a form with the form data according to embodiments of the present invention.

FIGS. 6A and 6B depict a method for transferring data between a remote server and a service provider client according to embodiments of the present invention.

FIG. 7 depicts an example of a new client record web form page on a client's system or database that also includes an icon for an application to facilitate data transfer according to embodiments of the present invention.

FIG. 8 depicts an example of a user interface that the application/browser extension provides to a client user according to embodiments of the present invention.

FIG. 9 depicts a larger view of the browser extension/add-on window user interface 805 that may be provided to a client according to embodiments of the present invention.

FIG. 10 depicts an example of pre-fill or pre-transfer user interface display that shows a comparison of data and can receive input from a user according to embodiments of the present invention.

FIG. 11 depicts an example of visual indicators that highlight which fields in the web form have had data entered into them as part of the data transfer according to embodiments of the present invention.

FIG. 12 depicts an alternative method for transferring data between a client's target database and a service provider's source database according to embodiments of the present invention.

FIG. 13 depicts a block diagram of an example of a computing system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or instructions on a tangible computer-readable medium.

Also, it shall be noted that steps or operations may be performed in different orders or concurrently, as will be apparent to one of skill in the art. And, in instances, well known process operations have not been described in detail to avoid unnecessarily obscuring the present invention.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules. Components or modules may be implemented in software, hardware, or a combination thereof.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of such phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. A listing, set, or group shall be understood to include any number of items.

Embodiments of the present invention presented herein will be described using examples of customer records and using examples of web applications. These examples are provided by way of illustration and not by way of limitation. One skilled in the art shall also recognize the general applicability of the present inventions to other applications.

### A. INTRODUCTION

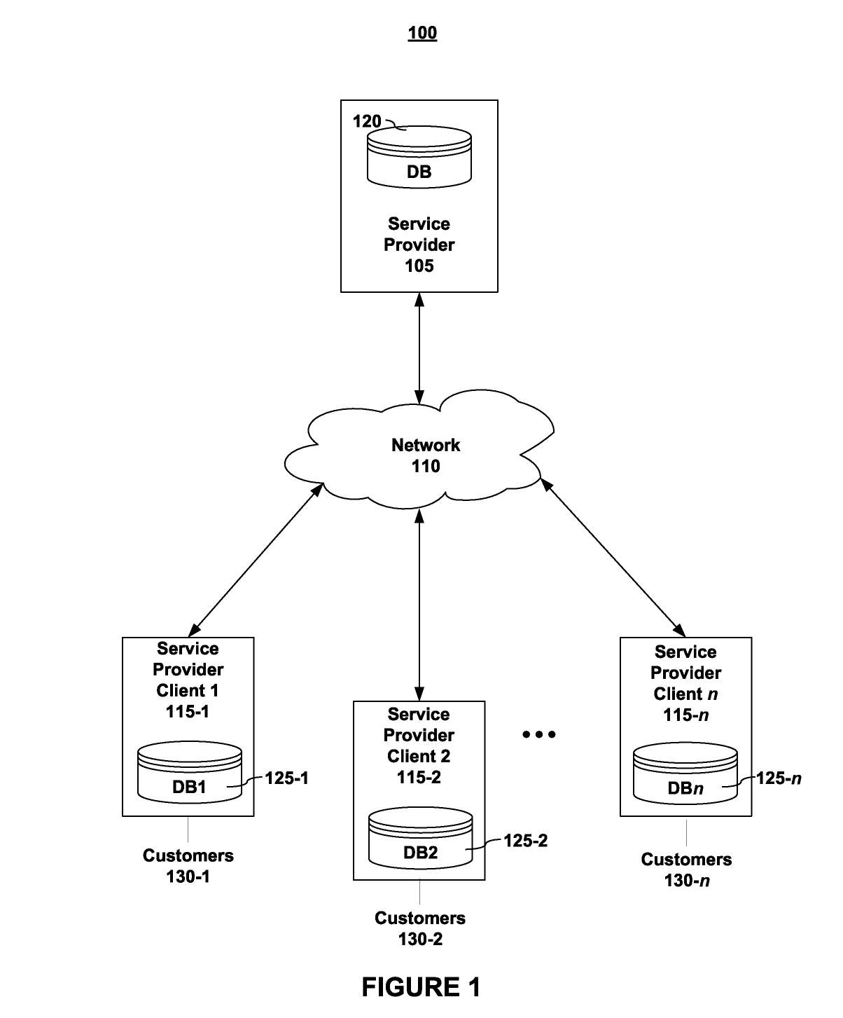

FIG. 1 depicts a typical environment in which aspects of the present invention may operate according to embodiments of the present invention. As shown in FIG. 1, a service provider 105 is communicatively coupled via a network 110 to one or more service provider clients (clients 115-1 through 115-n) that utilize one or more services offered by the service provider 105.

Consider, by way of example and not limitation, a company, such as Smartwavier of Bend, Oreg. Smartwaiver is a service provider that offers a service whereby Smartwaiver's clients (e.g., clients 115-x) can have their customers (i.e., the client businesses' end-users) complete electronic releases of liability (i.e., waiver forms). Such service can be advantageous for a number of reasons. First, clients 115-x can offload the complexity of creating, owning, maintaining, and operating an electronic forms system to the service provider and thereby focus their resources on the business. Second, the electronic forms are stored at the service provider's system, thereby reducing paper and electronic storage for the clients. Third, related to the second reasons is archiving; the service provider can archive the forms for future use by the clients (such as lawsuits, data gathering, etc.). Fourth, the electronic format makes it easy for customers of the clients to enter their data. One skilled in the art shall recognize other advantages to hiring such a service.

In the depicted embodiment, the service provider 105 includes a database/data store system 120 to store the data received from the customers of its clients 115-x. Each of the service provider clients 115-x may also include one or more database/data store systems 125-x. As previously discussed, the database systems employed by the various service provider clients 115-x are likely to not only be different from the one used by the service provider 105 but also to be different from each other. Often the service provider clients 115-x want the data for their customers that have been received by the service provider; however, these different database systems make transfer of data at best difficult, if not practically impossible. Furthermore, this problem only escalates as the service provider obtains more clients.

Accordingly, aspects of the present invention include systems and methods that facilitate transfer of data from an accessible database, which may be referred to herein for sake of convenience of identification and not by way of limitation as a “source database,” “server database,” “remote server database,” “service provider database,” or the like into forms, such as web forms, that manipulate one or more databases, which may be referred to herein for sake of convenience of identification and not by way of limitation as a “service provider client database,” “client database,” “destination database,” or the like.

In embodiments, the data transfer occurs even where an application may not have access to modify directly the destination database. In embodiments, the data transfer may be facilitated via user-initiated web form filling that can dynamically adapt based on communication with a remote server. It shall be noted that one aspect of the novelty of such a system is that one entity is using form filling to enter data, not for itself, but for a third-party.

### B. EMBODIMENTS OF DATA TRANSFER

Consider again, by way of example and not limitation, a company such as Smartwavier—a service provider that offers a service whereby Smartwaiver's clients can have their customers (i.e., the client businesses' end-users/customers) complete electronic releases of liability (i.e., waiver forms). When a waiver is completed, two separate resources may be created: 1) a PDF of the signed document, and 2) a record of the customer's/end user's information (e.g., name, address, etc.) within a database managed by Smartwaiver.

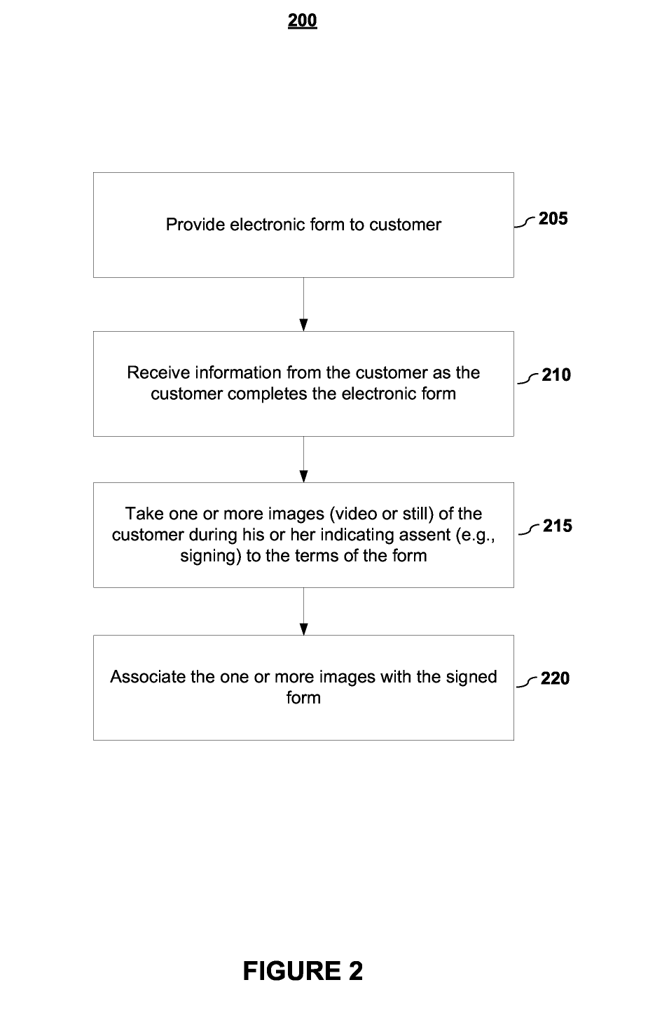

FIG. 2 depicts a method by which a form is completed according to embodiments of the present invention. In embodiments, an electronic release may be presented 205 to a customer with a system that includes one or more cameras. For example, in embodiments, a customer (e.g., 130-x) may be given a tablet computer with an electronic form. The customer uses the tablet computer to review the terms and conditions and to input data 210 into the form by supplying requested information, such as name, address, contact information, etc. In embodiments, during the execution (signing) of the form, the one or more cameras in the table may take 215 one or more still images or one or more video images of the individual as he or she indicates his or her assent to the terms and conditions of the form. The image(s) may be linked to, embedded in the document, stored, or otherwise associated 220 with the electronic record of the waiver. In embodiments, the image(s), the signing of the waiver, or both may include timestamping or other mechanism for security or authentication. It shall be noted that other items besides waivers or contract may be provided by the entity. For example, it may be user account information or other data.

Since the customer has entered his or her information into the service provider's system (e.g., Smartwaiver's system), one challenge is to get that information into the system of the client of the service provider. This issue can be especially challenging because a service provider provides services to a number of clients, and these clients likely use a variety of different point-of-sale (POS) or customer-record-management (CRM) systems. Regardless, these clients ultimately want the information from their customer's waiver to be transferred to a customer record within their POS/CRM database(s).

One skilled in the art shall recognize that for a number of reasons, it is not feasible or desirable to attempt to automatically add or update these customer records within the client's POS/CRM database. First, the service provider may not be able to directly access, such as via APIs, its clients' databases to be able to create or edit entries. Second, even assuming it were possible to get direct access, this access would be needed to each database. As a practical matter, it would be impossible for the service provider to attempt to manage relationships with the thousands of independent software vendors who produce the POS/CRM systems. Furthermore, keeping the interfaces with these myriad databases current as they continually make changes would be impractical, if not impossible. Many of these databases are also rendered directly inaccessible due to firewalls or other security restrictions.

Additionally, and less obvious, in embodiments, it can be important that a human make the final decision when transferring or updating the information on a specific customer record. A human being can determine if a new customer record should be created in the client database, or if an existing record already exists for the client and the information should simply be updated. In embodiments, this human oversight can be very difficult to eliminate, and in fact is desirable because of all the various misinformation that can be contained in the old or new customer record, such as name changes, mistyped data, etc.

By using form filling to transfer information from the service provider to the target POS/CRM system, such a methodology provides the service provider client the opportunity to make intelligent decisions regarding whether this information is for a new or an existing customer, and what specific information should be transferred. Form filling allows a user/operator at the service provider client to review and confirm the appropriate transfer of information into the proper customer record and simultaneously transfer the information with a minimal amount of effort.

In embodiments, the form filling may be facilitated via a browser extension (also known as browser add-ons) although one skilled in the art shall recognize that other implementations may be also used. One skilled in the art shall recognize that a browser extension embodiment has several advantages. For example, it provides a convenient interface. Second, it does not require APIs or direct database access to interface with the CRM/POS database. Third, it can allow for additional functionality and interfaces that enhance the fill operation, including allowing for human interaction as well as allowing code to be sent the browser for execution. Additionally, it functions in the browser environment which allows for cookies and other browser functionality to operate as normal. One skilled art shall recognize other advantages.

As mentioned above, one aspect of the present invention is a photo verification feature, which allows clients of the service provider to capture photographs of their participants while the participants are completing one or more parts of a form. For example, when a person is signing a waiver form, a photograph may be taken and appended to the waiver's PDF document; this photographic evidence may be used as an additional means of verifying who completed the waiver.

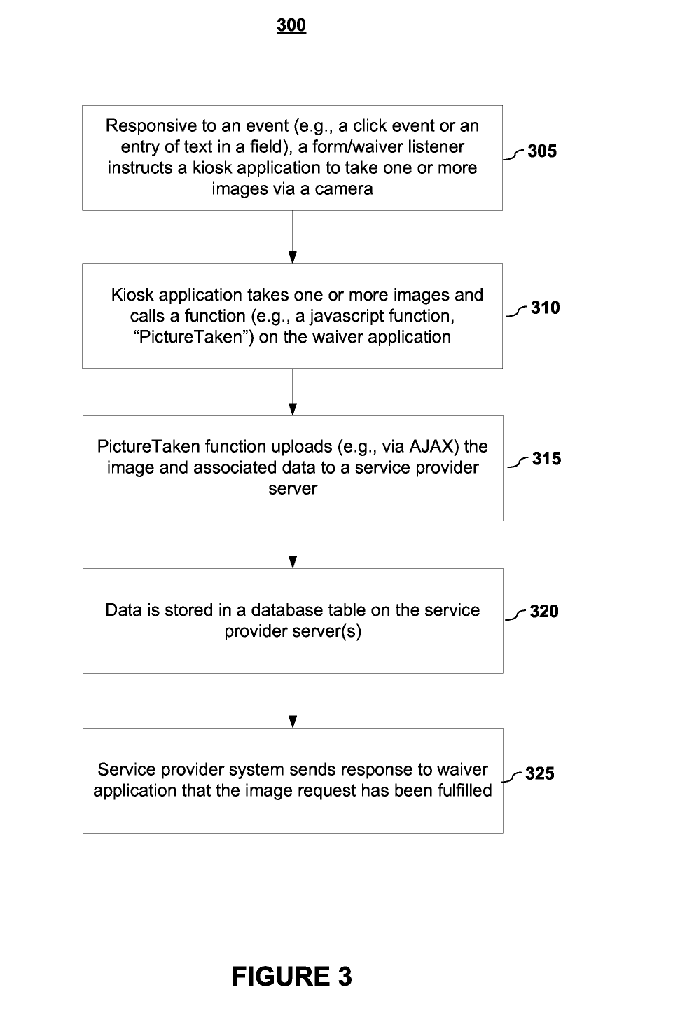

In embodiments, a service provider (e.g., Smartwaiver) may provide a kiosk application or applications that can capture images (video or still) via a device's camera (e.g., webcam on tablets, mobile phones, laptops, and desktop computers) or other controllable camera. In embodiments, the service provider's web form (such as a waiver form) listens for certain events. When one of the events occurs, the web form can tell the kiosk application to capture one or more images and return at least one of the captured images to the form application. In embodiments, the image may be returned via javascript. FIGS. 3-5 depict more detailed embodiments of methods for providing a photo verification feature.

FIG. 3 depicts a method by which one or more images are captured during the process of completing a form according to embodiments of the present invention. In embodiments, a form listener instructs (305) a kiosk application (which may be implemented as part of the web form application, and/or as a separate application, feature, or add-on) to capture one or more images via a camera in response to an event. In embodiments, an event may the act of signing, one or more electronic signature consent checkboxes, entry of text into one or more fields (e.g., the completion of the participant's first name), and the like. Images may be captured for one such event or for a plurality of events. In embodiments, when the form application instructs the kiosk application to capture an image, it may specify one or more parameters, such as one or more of the following: (1) tag—a description of what prompted the event (e.g., which signature box); (2) width—the final width of the signature (e.g., 300 pixels); (3) image type—specify whether the image should be color or black and white; (4) quality—specify what level of compression (if any) should be used; and (5) video capture vs. still image capture. One skilled in the art shall recognize that other parameters may be specified and that one or more these parameters may be user selected.

Having received instructions to capture one or more image, the kiosk application takes (310) the one or more images and calls a function (e.g., a javascript function, “PictureTaken”) on the form application. It shall be noted that in embodiments, face recognition software, which is common in the field of image processing, may be used to check that a face has been captured in the image. If it has not, a prompt may be sent to the form filler to position his or her face toward the camera and another image or images may then be captured. In embodiments, the PictureTaken function uploads (e.g., via AJAX) (315) at least one image to the service provider system (e.g., Smartwaiver's system). In embodiments, associated data may also be uploaded to the service provider server. In embodiments, the AJAX request may pass one or more of the following: (1) Base64—raw image data; (2) Image Source—what image file type was originally used (e.g., JPEG, GIF, PNG, etc.); (3) the Tag (which was described above); (4) SessionID—a unique identifier for the form; and (4) Credential—an encrypted string which the kiosk application generates to show that it is an authentic service provider kiosk app.

In embodiments, the data is stored in one or more database tables on the service provider server(s). For example, in embodiments, all of the data, except the base64 data, is stored in a database table on the service provider's server. In embodiments, the base64 data is encrypted and stored in the cloud, and the file path of the encrypted base64 data is stored in the database so it can be accessed in the future. In embodiments, a timestamp is also stored in the database.

In embodiments, the service provider system sends (320) a response to waiver application that the image request has been fulfilled.

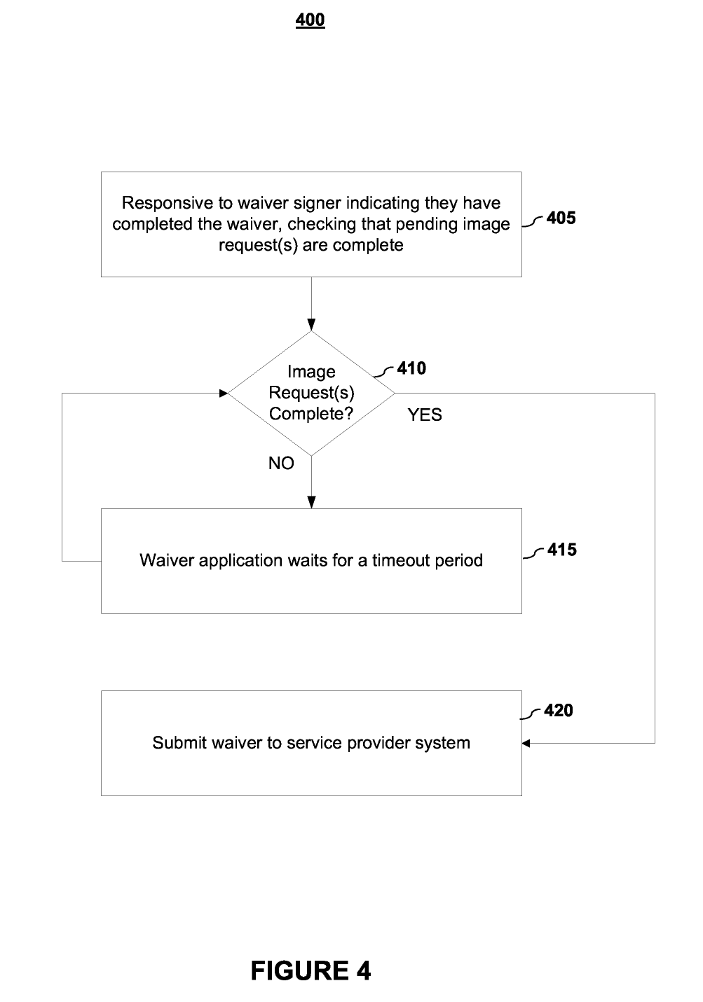

FIG. 4 depicts a method in which the image capture request process is checked for completion prior to submitting form data to a service provider system according to embodiments of the present invention. Responsive to the signer of the form indicating they have completed the form, the form application checks (405/410) that pending image request(s) are complete. If there are any pending image requests, the form application may wait (415) a specified time period to allow the image request to finish processing. In embodiments, after the time period has expired, the application checks (410) again if the requests have been completed. This process can repeat until all requests are completed. In alternative embodiments, after a set number of iterations, the system may send an alert, cancel or ignore the pending request, and/or restart the capture process. Once the application is cleared to proceed, the form data (e.g., a waiver) is submitted (420) to the service provider system.

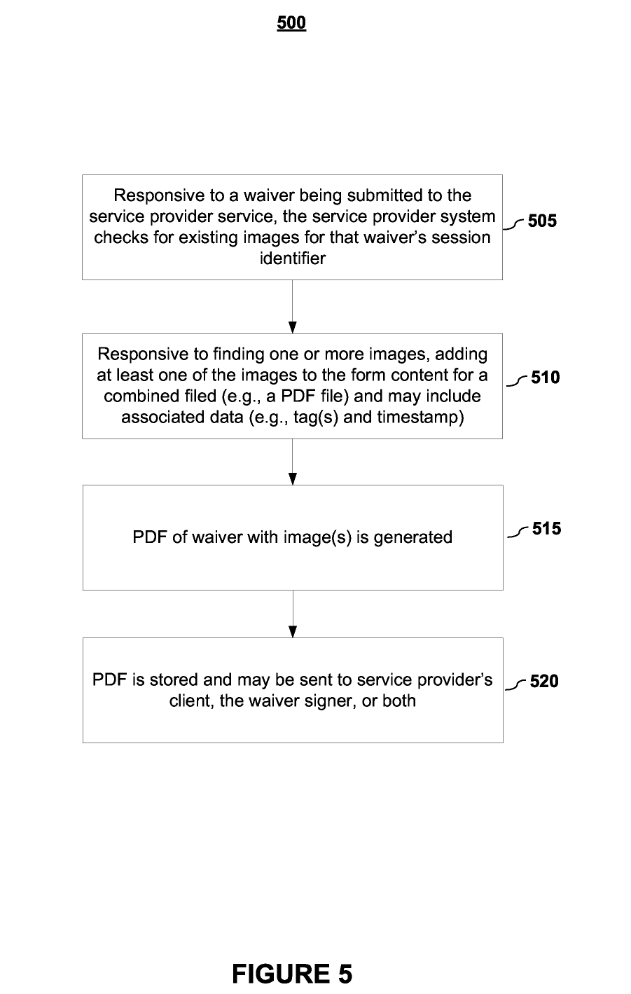

In embodiments, after a form has been submitted by the form signer/completer but before a PDF is generated on service provider system, the system may incorporate or associate one or more images with the form. FIG. 5 depicts a method for combining one or more captured images of a person completing a form with the form data according to embodiments of the present invention. In embodiments, in response to a waiver being submitted to the service provider service, the service provider system checks (505) for existing images for that form's session identifier. If one or more one or more images are found, at least one of the images may be added (510) to the form content to create a combined file that links or combines the form content data and the one or more images. For example, the form content and an image or images may be combined in a portable document format (PDF) and may include associated data (e.g., tag(s) and timestamp). For example, in embodiments, one or more webcam images may be added to the form content for the PDF file's creation, including the image (which may be represented as a JPEG image), and the associated tag and timestamp. In embodiments, an example of a tag may be the person signature, or parent or guardian's signature, and a timestamp example may include the full date and time (e.g., 2013-03-11 10:02:03 UTC). In embodiments, the images may be shown or displayed in relation to the event that generated the image and/or may be displayed in timestamp order.

In embodiments, after this process is completed, a PDF (or other format) is generated (515) and permanently includes a copy of one or more images, tags, and timestamps taken during the form completion process by the participant. Finally, in embodiments, the PDF is stored and may be sent (520) to service provider's client, the form signer, or both.

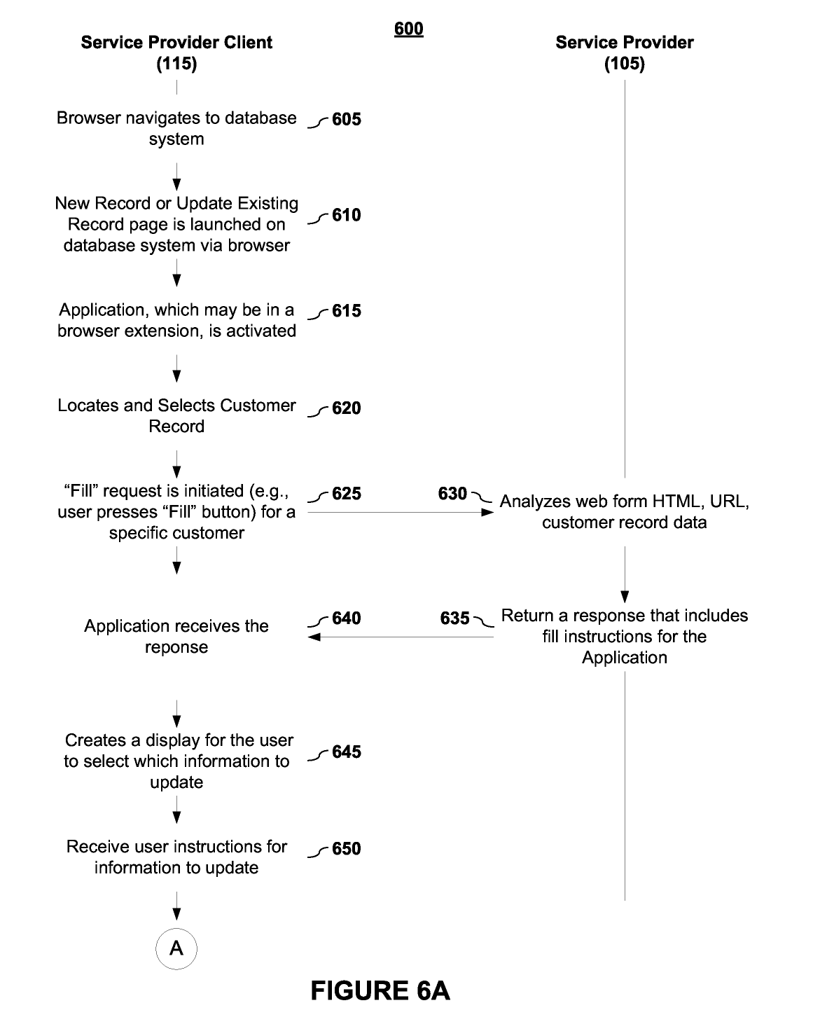

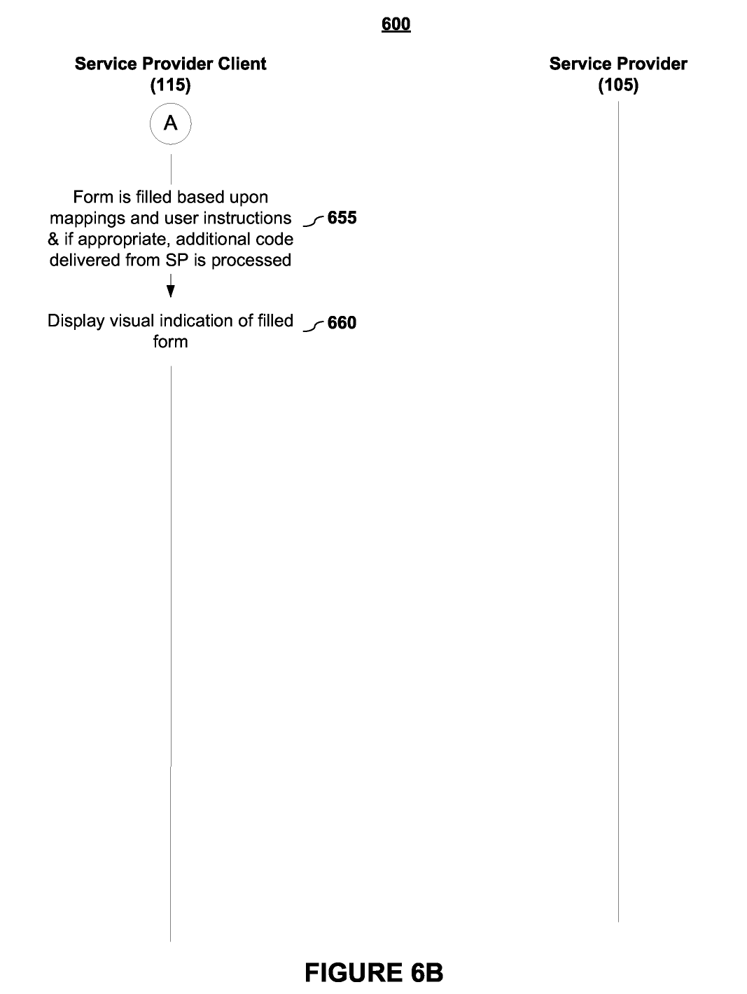

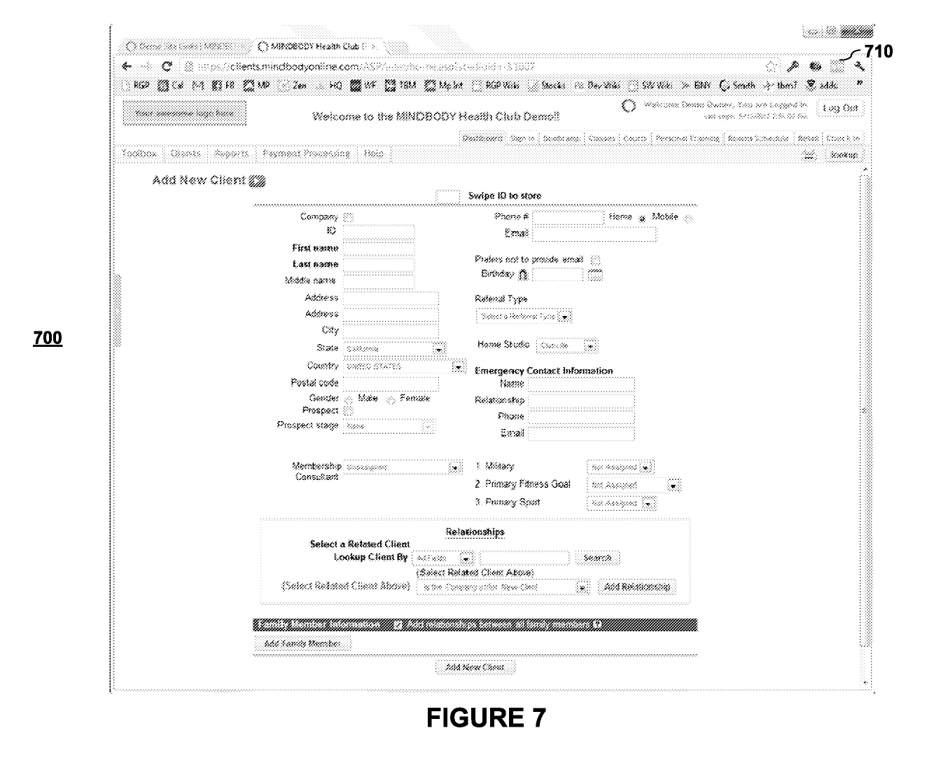

Turning now to FIGS. 6A and 6B, depicted is a method for transferring data between a remote server and a service provider client according to embodiments of the present invention. In the illustrated embodiment, a user accesses 605 a database system, such as a CRM or POS system, via a browser. Once the browser has connected with the client's database system, such systems typically offer the user a choice between entering a new record or updating an existing record. The user selects 610 one of those two options. FIG. 7 depicts an example of a new client record web form page 700 on a client's system or database. It shall be noted that this system or database may not be directly accessible by the service provider system that has the record data desired to be transferred into the client's system.

In embodiments, an application, which may be a browser extension or add-on, is activated by the user. FIG. 7 depicts an example of an icon 710 for a browser extension. Selecting the icon, for example by clicking on it, will cause the browser extension to be activated. In embodiments, the browser extension initially prompts a user to log into the service provider's system using a username and password or some other means of verification via remote login. It shall be noted that one benefit of using a browser extension or add-on is that browser features, such as cookies or autofill, may be used to help make login easier for a user. In embodiments, once a user has logged into the system, a default user interface display of the extension may be presented to the user (e.g., displaying to the user a list of recently completed forms that have been added to the service provider's data store).

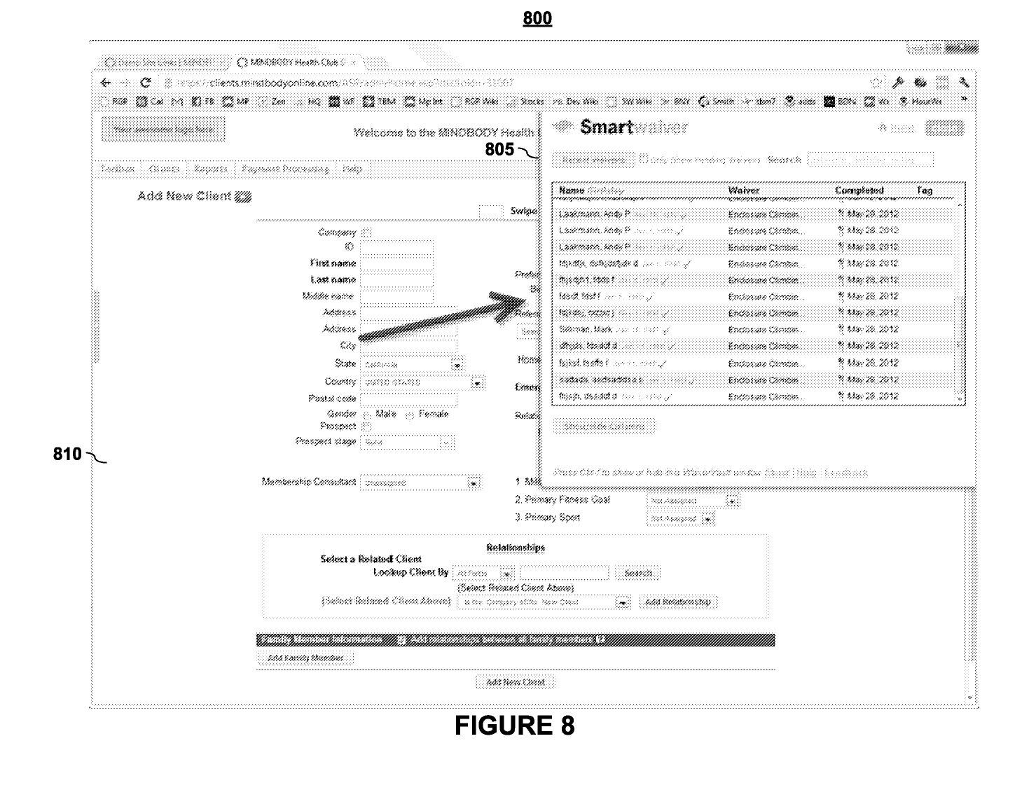

FIG. 8 depicts an example of user interface that the application/browser extension provides to a client user according to embodiments of the present invention. In the depicted example, a window 805 is displayed over the client record web form page 810, although one skilled in the art shall recognize that the particular mode by which the interface is displayed is not critical to the present invention. In embodiments, the browser extension/add-on window 805 provides access to the records at the remote service of the service provider.

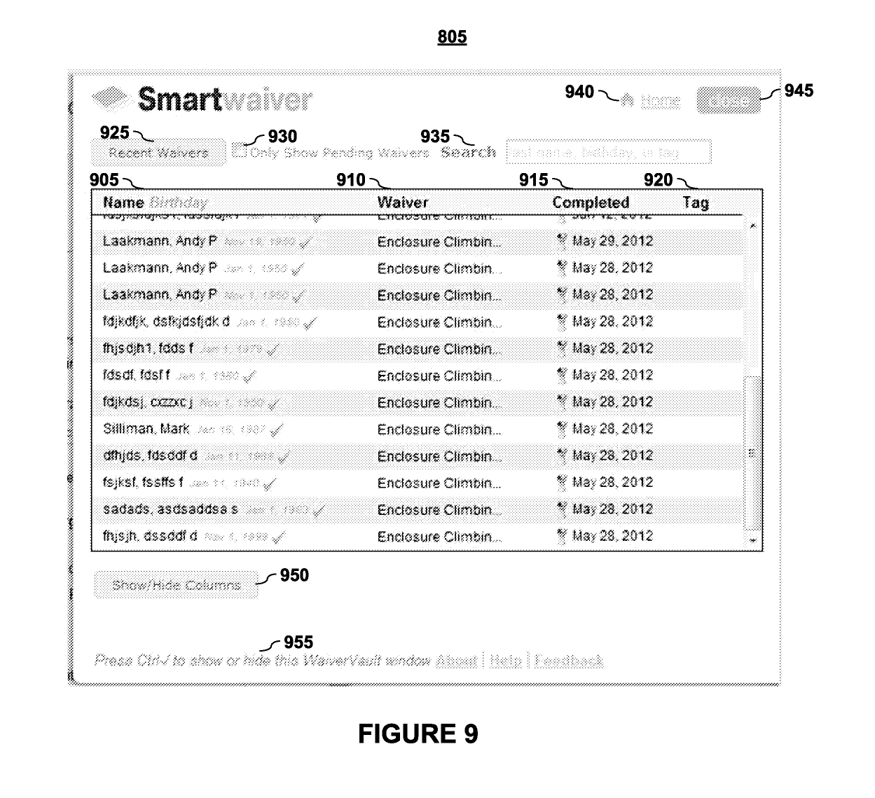

FIG. 9 depicts a larger view of the browser extension/add-on window user interface 805 that is provided to a client according to embodiments of the present invention. In embodiments, the browser extension window 805 lists information from the accessible database, namely the service provider's database. The customer information may comprise one or more fields of information from the source database records and/or a unique identifier. In the depicted embodiments, the window 805 comprises a listing of customers for that client and shows the fields of name and birthday 905, waiver type 910, date completed 915, and tags (which may be client-specific tags) 920. In embodiments, the user interface may be customizable to allow the client to decide which customer identifiers will be shown (e.g., selecting the “Show/Hide Columns” button 950 allows the client to select which fields to show or hide).

In embodiments, the user interface 805 may also include additional functionality. For example, the user interface 805 may include a “recent” 925 button that, when selected, causes only customer identifiers that satisfy a certain temporal rule or rules (e.g., all waivers signed within the past x days) to be displayed. In embodiments, the service provider may track which records have been added to the client's database and/or which records are new since the last transfer between the databases and will default to show the records that have not been previously added to the client's database or that are new since the last transfer. In embodiments, the various rules may be pre-set, customizable, or both.

In embodiments, the user interface 805 may allow for searching 935 of customers based upon or more factors. Additional features or functionality may be provided, such as selecting certain subsets of the listing (e.g., the check box 930 that will cause only pending waivers to be shown).

In embodiments, the user interface may include a home button 940 and a close button 945 to close the user interface window 805. In embodiments, selecting the home button brings the extension window back to a default display, such as the top display list of recently completed documents/forms. In embodiments, shortcut keys may be provided to facilitate user interactions (e.g., shortcut keys to show or hide 955 the user interface window 805).

The features and functionality presented herein are provided by way of example; one skilled in the art shall recognize that other features or functionality may also be added.

Returning to FIG. 6, a user for the client selects 620 a customer record that he or she wants added to the client database. The browser application sends a fill request to the service provider server. In embodiments, the fill request may comprise web form code, such as HTML code, the Uniform Resource Locator (URL), and existing record information, if any. The server analyzes this information to process the fill request. For example, the server may analyze its record data in its source database, the URL of the web form, and the underlying web form HTML to determine if: 1) the web form is capable of being filled; 2) which data from the source database can be transferred into the web form; 3) where in the web form each specific field in the source database data should be transferred; 4) what additional code instructions may be required for the application to properly fill those web form elements with the source database data; and 5) what code instructions may be required to visually communicate the transferred information to the user.

In embodiments, the communication with the remote server prior to every web form fill request provides flexibility for the application to adapt to any combination of web form and source data. The remote server communication also provides the ability to adapt to unexpected changes in the underlying web form as well as provide proper messaging to the user in the event that any information transfer cannot be properly executed.

Having analyzed the data, the server prepares and sends 635 a response to the application that has fill instructions. In embodiments, the response may include the data for insertion into fields in the record and a mapping to correlate the data from the source database to fields in the web form. In embodiments, the response may also include additional code to aid completion of filling the form, for highlighting changes, and/or for communicating messages to the user.

In embodiments, the application receives 640 the fill instructions/response from the remote server. In embodiments, if the server is unable to process the fill request for some reason, the response may be a message for the user indicating an error or otherwise noting that the fill request cannot be processed at this time.

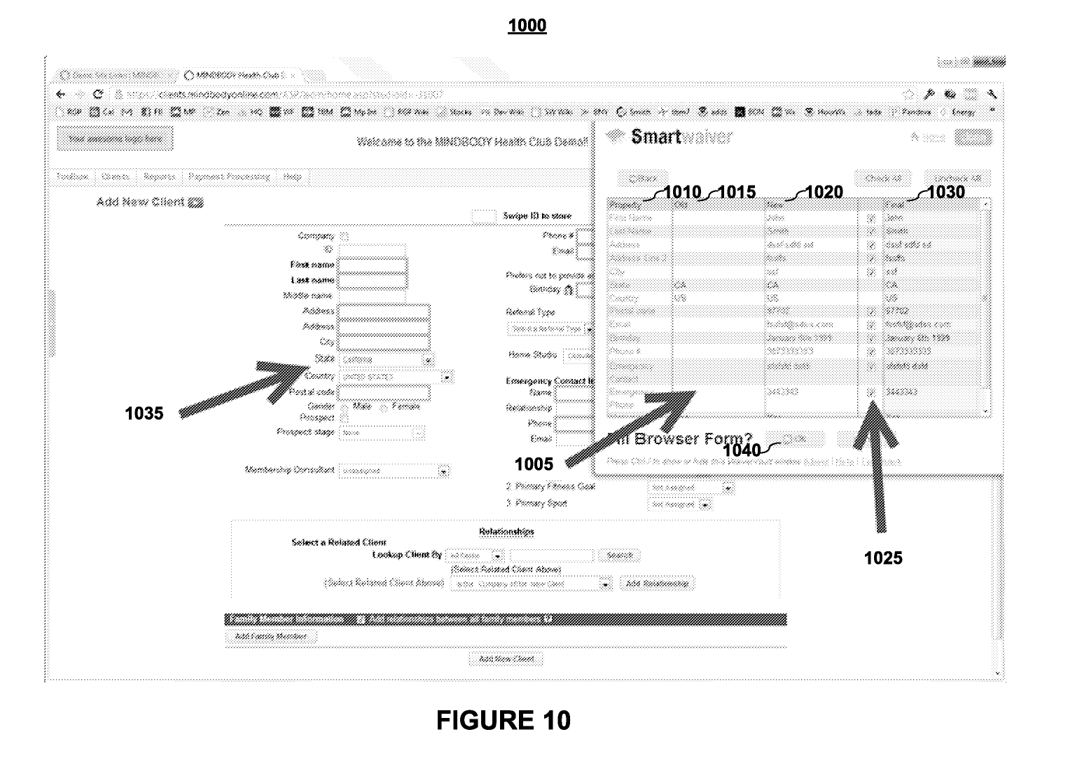

Assuming no errors that would stop the process, in embodiments, the application processes the response and creates 645 a display that allows the user to select which fields to be entered into the target, or client, database. Such an embodiment is particularly beneficial if the fill request is for an existing record. If there is already data in the target database, the client may not want to overwrite it with data from the source database. Thus, in embodiments, the applicant takes the existing values from the web form and combines this data with information from the response to create a user interface display that can allow a user to select which information to update. FIG. 10 depicts an example of user interface display that shows a comparison of data and can receive input from a user according to embodiments of the present invention.

Depicted in FIG. 10 is a pre-fill or pre-transfer user interface window 1005 that shows a comparison of the source database data from the service provider and the data from the target database at the client. The depicted embodiment includes a listing of the fields or properties 1010 for that record and the corresponding old values 1015, and new values 1020. In embodiments, the interface can receive input from the user indicating whether the new value should be accepted or not. In the depicted example, a checkbox 1025 is provided for each potential value change and a user can select which new values to accept. For convenience, the user interface may display a preview 1030 that lists which values will be in the record following the transfer.

In embodiments, the application may highlight 1035 the target fields in the web form that may be affected. In embodiments, the fields that are highlighted may be any field that contains a value in the source database record. Alternatively, the fields that are highlighted may be only those fields that will receive a new value from the source database record. Thus, in embodiments, the highlighted fields may change as the user uses the checkboxes 1025 to select which fields will be changed.

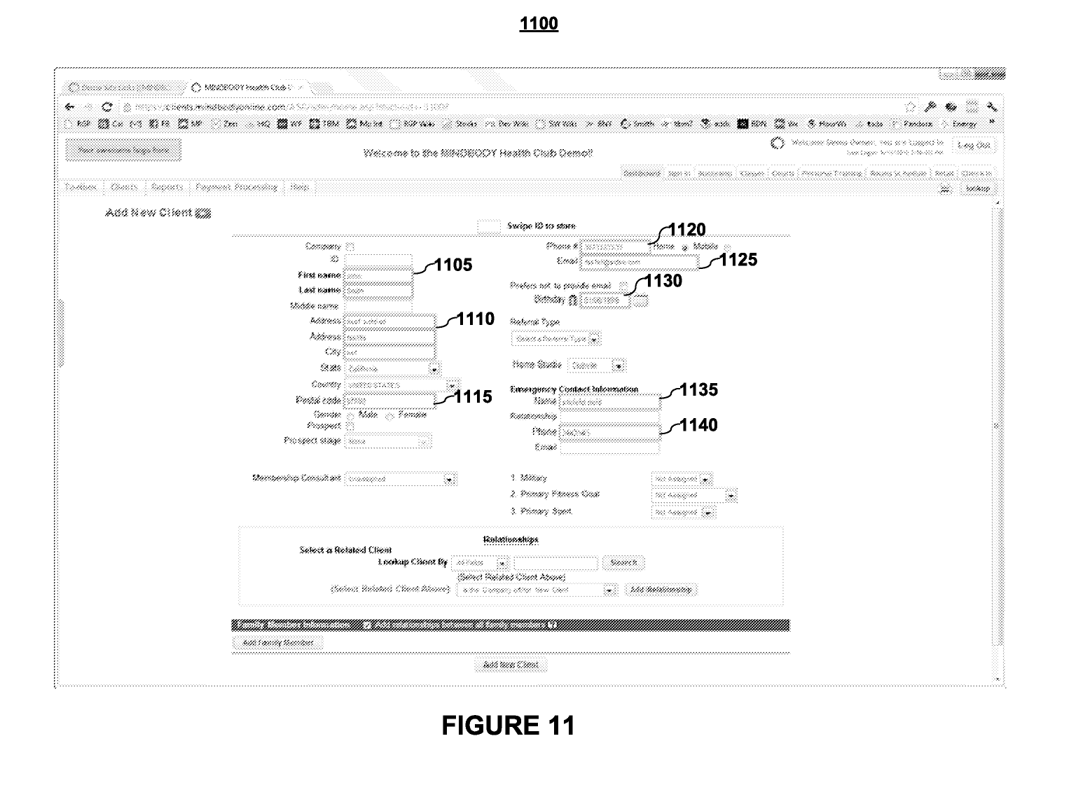

Once a user is satisfied with the data mapping, he or she can execute the transfer 650. In embodiments, the user may execute the transfer by clicking on a button, such as “OK” button 1040. The application receives the transfer mappings and completes the data transfer by filling 655 the data into the web form in the appropriate fields. In embodiments, an indicator or indicators may be used to highlight 660 the changed data. FIG. 11 depicts an example of visual indicators, highlighted boxes (e.g., 1105-1140), that highlights which fields in the web form have had data entered into them as part of the data transfer.

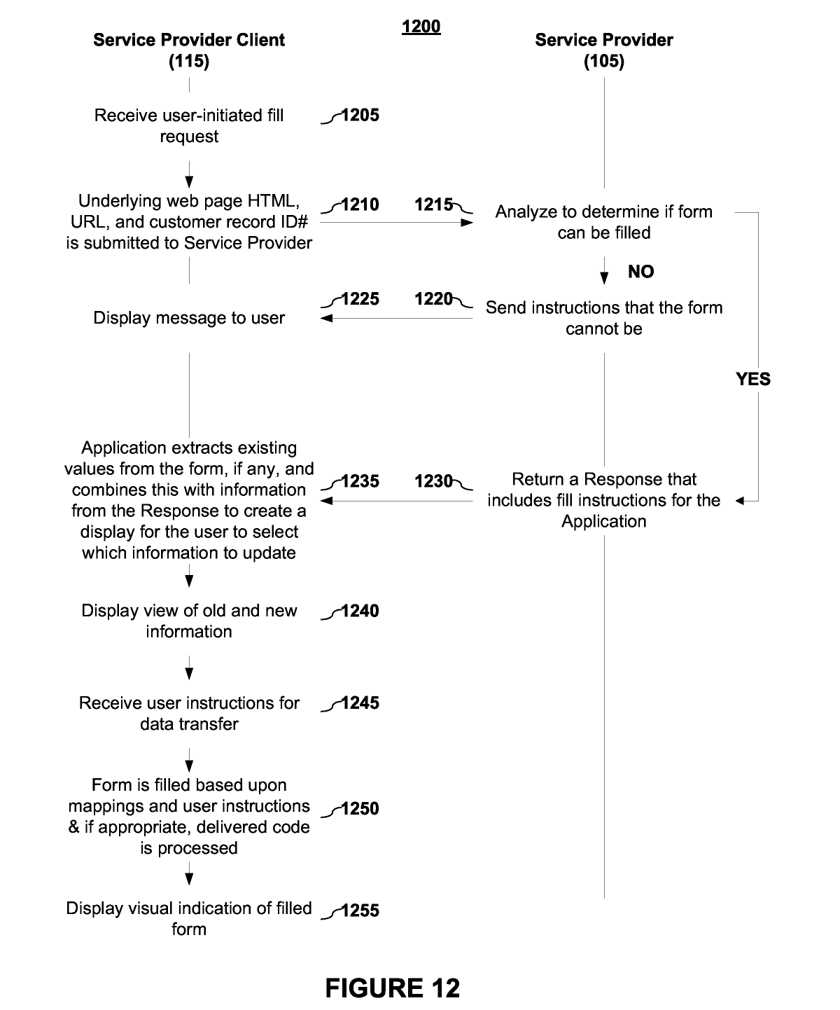

FIG. 12 depicts an alternative method for transferring data between a client's target database and a service provider's source database according to embodiments of the present invention. In embodiments, an application interfaces with a form filling page for the client's database system. A user-initiated fill request is received 1205 via the fill request. In embodiments, the interface may provide identifiers of records, or a subset thereof, for the client at the source database. A selection of a record by the user causes the application to send 1210 a fill request to the service provider system. In embodiments, the fill request comprises the underlying web page HTML, URL, and customer record identification number. In embodiments, the URL is useful to send because it can contain values and other useful information. Responsive to receiving the fill request, the service provider analyzes 1215 the information to determine whether the form of the client's database system can be filled. If the form cannot be filled, the service provider system sends 1220 instructions to the application at the client's to so notify the client. The application receives the instructions and displays 1225 that message to the client user. Examples of when the form may not be filled include a new forms or forms that have changed significantly and from which the service provider cannot extract any meaningful information about how to fill. In these cases, in embodiments, the service provider may be notified and can apply the appropriate changes to support the new or changed form.

However, if the form can be processed, the service provider system returns 1230 a response that comprises fill instructions for the application. In embodiments, the fill instructions may comprise record data elements and field mappings that map fields in the target database form with fields in the source database for these data elements. The fill instructions may also include code that may be operated at the client's site to help facilitate the data transfer. Responsive to receiving the fill instructions, in embodiments, the application extracts 1235 existing values from the form, if any, and combines these data elements with information from the response to create 1240 a display for the user to select which information to update.

The user may then review and select which data elements to be transferred from the source database to the target database. Once the user is satisfied with the transfer mappings and data field selections, the user indicates his or her acceptance to the application. The application uses the user transfer mappings for the data transfer, whereby the form is filled 1250 based upon the mappings. In embodiments, additional delivered code is also processed. Additional code may include separate code used to facilitate data entry in the form such as selecting radio buttons, check boxes, filling in prepopulated fields, and the like. In embodiments, the additional code may also include causing visual indicators in the web form to highlight which fields received data. Some other uses of the delivered code include: (1) causing a message to be displayed to the user that might be specific to this form filling request; (2) using it to deliver “pauses” when fields need to be filled in a particular order, and the first field triggers something on the form that needs to be processed prior to the second filling.

It shall be noted that, in embodiments, information in the client record system may be used to update records in the service provider system. This may be particularly applicable where the transfer mapping is different than the initial mapping provided by the service provider. In embodiments, the application, the client record system, the service provider system, or some combination thereof may maintain versions of the different records.

### C. EMBODIMENT OF APPLICATION/SERVER PROCESSING, ANALYSIS, AND RESPONSE

### 1. Initial Form Processing Embodiments

As discussed above, in embodiments, the service provider system receives from a user of a client a fill request. The fill request may include the application sending the following information to the remote server: (1) a selected record identifier in the source (accessible) database at the service provider; (2) URL in browser window; and (3) HTML for the underlying document/web form.

As noted previously, in embodiments, the server receives this request and analyzes the HTML, URL, and data stored in the customer record to determine what fields, if any, may be filled. The server may use many different methods to analyze the incoming fill request to determine what underlying fields on the web form can be filled. For example, in embodiments, for client systems that have been previously identified, a look-up system may be utilized that checks the incoming URL against a known list of supported URLs representing specific forms on specific client systems. Once a specific client system and form has been identified, the server would analyze the HTML to confirm that the expected fields are still contained within the underlying document/web form identified by the URL. This secondary check has the benefit of allowing the server to log when the underlying document/web form has changed on the targeted client system. In embodiments, the server may also search for a known set of HTML elements that positively identify a particular form on a particular database system.

If a known form on a system is not identifiable by either the URL or by a set of known HTML elements, the server may look for fields with typical identifiers such as “last name,” “first name,” “home phone,” etc. and still attempt to provide a form filling operation.

Additionally, all form filling commands and their analysis may be logged on the server, allowing for new forms and client data systems to be identified and, if needed, that form and database system may be added to the list of known systems with predetermined mappings. In embodiments, after analysis, if the server does not know how to fill this form, a message may be displayed to the user.

In embodiments, the application may present the fields in both databases and allow the user to form the mapping. Such embodiments are particularly helpful when the form is unknown to the service provider system. In embodiments, the display of the fields may be done by providing a user interface that includes both sets of fields, similar to the user interface of FIG. 9. Such a user interface may be configured to receive input from the user via selecting paired fields, dropping and dragging, or otherwise indicate which fields should be mapped to each other. In embodiments, the interface may display the service provider's default or estimated mappings and allow the user to correct or change any mappings with which he or she does not agree. In embodiments, the application, the service provider system, or both may provide an interface to allow development of mappings for forms.

### 2. Embodiments of Additional Code with Fill Instructions

Responsive to being able to generate a response with fill instructions, in embodiments, an XML response is returned to the application. In embodiments, the fill response may comprise any of the following primary sections. First, the fill response comprises a list of specific form field mappings and code, such as javascript code, specific to certain fields. Second, the fill response may comprise optional code, such as javascript code, to run in the client's browser immediately. For example, the form may need to be prepared to receive the data transfer, such as hidden fields need to be unfolded or exposed so that the application can interact with those fields. While the hidden fields may be able to be filled without revealing the fields, this process may not be desired by the user who may want to see all the fields that are affected by a data transfer. Third, the fill response may comprise optional code, such as javascript code, to run if the customer confirms the fill request. For example, code may be used to complete a data transfer when the web form includes fields that require some interaction. Consider, for example, a web form that has a “Country” field that is a dropdown list and affects the dropdown list of a “State/Province” field. In embodiments, code, such as Asynchronous JavaScript and XML (AJAX), may be used to first set the “Country” field, and after that has been set and the “State/Province” field updated accordingly, set the appropriate “State/Province” field. Finally, the fill response may comprise optional warning message. For example, a warning might be provided if the State/Province that should be filled is not available in the dropdown list.

In embodiments, each specific form field mapping may comprise one or more of the following elements. First, the fill instructions may include a mapping of which web form field to update either by web element ID or NAME.

Second, the fill instructions may include the “user friendly name” of that field to display in the confirmation display and may include the “new value” that will be assigned to the field.

Third, the fill instructions may include a hint of the “old value,” if the application cannot determine the old value. Some forms are not easy to automatically interpret. Thus, depending upon the nature of the form, it may be unclear what should be a field name or field value. For example, with radio buttons and check boxes, the value being displayed is not always part of the label. It may be that some text next to the button or box defines the field or its value. Getting the checked/unchecked status without getting the correct associated label results is not fully descriptive. To obtain a field or a field value, the form may be analyzed and reasonable conclusions drawn, but it still may be incorrect. By listing the item as a “hint” or “best guess,” a user may review, and if desired edit, the item.

Fourth, the fill instructions may include the type of web form control being targeted (text box, check box, select box, etc.).

Finally, the fill instructions may include optional code, such as javascript code, that can be executed specific to this element. For example, in addition to the visible field being modified, a hidden field may also need to be modified; thus, additional javascript code may be delivered to modify the hidden field. Or, as described previously, a “pause” may be delivered so that related fields can be updated (e.g., updating the “Country” field, pausing, then updating the “State/Province” field).

One skilled in the art shall recognize other elements that may be included as part of the fill instructions.

### D. COMPUTING SYSTEM IMPLEMENTATIONS

In embodiments, one or more computing system may be configured to perform one or more of the methods, functions, and/or operations presented herein. Systems that implement at least one or more of the methods, functions, and/or operations described herein may comprise an application or applications operating on at least one computing system. The computing system may comprise one or more computers and one or more databases. The computer system may be a single system, a distributed system, a cloud-based computer system, or a combination thereof.

It shall be noted that the present invention may be implemented in any instruction-execution/computing device or system capable of processing data, including, without limitation phones, laptop computers, desktop computers, and servers. The present invention may also be implemented into other computing devices and systems. Furthermore, aspects of the present invention may be implemented in a wide variety of ways including software (including firmware), hardware, or combinations thereof. For example, the functions to practice various aspects of the present invention may be performed by components that are implemented in a wide variety of ways including discrete logic components, one or more application specific integrated circuits (ASICs), and/or program-controlled processors. It shall be noted that the manner in which these items are implemented is not critical to the present invention.

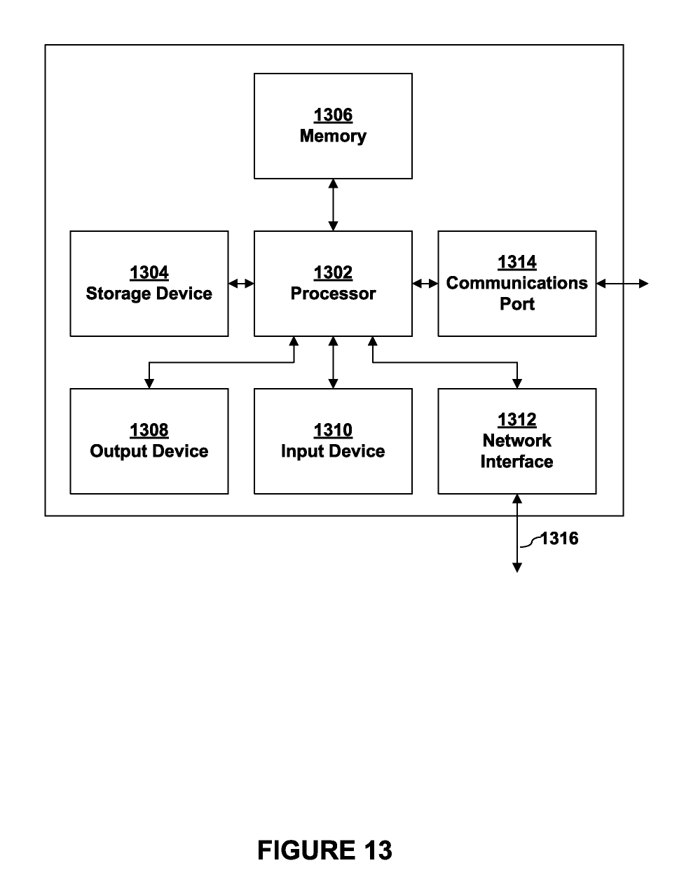

FIG. 13 depicts a functional block diagram of an embodiment of an instruction-execution/computing device 1300 that may implement or embody embodiments of the present invention, including without limitation a client and a server. As illustrated in FIG. 13, a processor 1302 executes software instructions and interacts with other system components. In an embodiment, processor 1302 may be a general purpose processor such as (by way of example and not limitation) an AMD processor, an INTEL processor, a SUN MICROSYSTEMS processor, or a POWERPC compatible-CPU, or the processor may be an application specific processor or processors. The processor or computing device may also include a graphics processor and/or a floating point coprocessor for mathematical computations. In embodiments, a storage device 1304, coupled to processor 1302, provides long-term storage of data and software programs. Storage device 1304 may be a hard disk drive and/or another device capable of storing data, such as a magnetic or optical media (e.g., diskettes, tapes, compact disk, DVD, and the like) drive or a solid-state memory device. Storage device 1304 may hold programs, instructions, and/or data for use with processor 1302. In an embodiment, programs or instructions stored on or loaded from storage device 1304 may be loaded into memory 1306 and executed by processor 1302. In an embodiment, storage device 1304 holds programs or instructions for implementing an operating system on processor 1302. In one embodiment, possible operating systems include, but are not limited to, UNIX, AIX, LINUX, Microsoft Windows, and the Apple MAC OS. In embodiments, the operating system executes on, and controls the operation of, the computing system 1300.

An addressable memory 1306, coupled to processor 1302, may be used to store data and software instructions to be executed by processor 1302. Memory 1306 may be, for example, firmware, read only memory (ROM), flash memory, non-volatile random access memory (NVRAM), random access memory (RAM), or any combination thereof. In one embodiment, memory 1306 stores a number of software objects, otherwise known as services, utilities, components, or modules. One skilled in the art will also recognize that storage 1304 and memory 1306 may be the same items and function in both capacities. In an embodiment, one or more of the methods, functions, or operations discussed herein may be implemented as modules stored in memory 1304, 1306 and executed by processor 1302.

In an embodiment, computing system 1300 provides the ability to communicate with other devices, other networks, or both. Computing system 1300 may include one or more network interfaces or adapters 1312, 1314 to communicatively couple computing system 1300 to other networks and devices. For example, computing system 1300 may include a network interface 1312, a communications port 1314, or both, each of which are communicatively coupled to processor 1302, and which may be used to couple computing system 1300 to other computer systems, networks, and devices.

In an embodiment, computing system 1300 may include one or more output devices 1308, coupled to processor 1302, to facilitate displaying graphics and text. Output devices 1308 may include, but are not limited to, a display, LCD screen, CRT monitor, printer, touch screen, or other device for displaying information. Computing system 1300 may also include a graphics adapter (not shown) to assist in displaying information or images on output device 1308.

One or more input devices 1310, coupled to processor 1302, may be used to facilitate user input. Input device 1310 may include, but are not limited to, a pointing device, such as a mouse, trackball, or touchpad, and may also include a keyboard or keypad to input data or instructions into computing system 1300.

In an embodiment, computing system 1300 may receive input, whether through communications port 1314, network interface 1312, stored data in memory 1304/1306, or through an input device 1310, from (by way of example and not limitation) a scanner, copier, facsimile machine, server, computer, mobile computing device (such as, by way of example and not limitation a phone or tablet), or other computing device.

In embodiments, computing system 1300 may include one or more databases, some of which may store data used and/or generated by programs or applications. In embodiments, one or more databases may be located on one or more storage devices 1304 resident within a computing system 1300. In alternate embodiments, one or more databases may be remote (i.e., not local to the computing system 1300) and share a network 1316 connection with the computing system 1300 via its network interface 1314. In various embodiments, a database may be a database that is adapted to store, update, and retrieve data in response to commands.

In embodiments, all major system components may connect to a bus, which may represent more than one physical bus. However, various system components may or may not be in physical proximity to one another or connected to the same bus. In addition, programs that implement various aspects of this invention may be accessed from a remote location over one or more networks or may be conveyed through any of a variety of machine-readable medium.

One skilled in the art will recognize no computing system or programming language is critical to the practice of the present invention. One skilled in the art will also recognize that a number of the elements described above may be physically and/or functionally separated into sub-modules or combined together.

It shall be noted that embodiments of the present invention may further relate to computer products with a tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A computer-implemented method for facilitating transfer of data for a record between a service provider system and a client records system, the method comprising:
generating a user interface that presents to a user via a browser a listing of one or more records available from a data store of a service provider system, wherein a record comprising a set of fields and data elements associated with at least some of the fields;
responsive to receiving from the user via the user interface a selection of a record identifier from the listing of one or more records available from the data store of the service provider system, sending a request to the service provider system, the request comprising the selected record identifier and information associated with a form that is used to enter data into the client records system and is accessible via the browser;
receiving a response from the service provider system, the response comprising:
a set of data elements for the selected record from the data store of the service provider system; and
fill instructions that comprise mappings that correlate at least one data element of the selected record with at least one field in the form of the client records system;
generating a pre-fill user interface that presents to a user the set of data elements for the selected record mapped to fields of the form of the client records system according to the mappings to allow the user to review the data elements to be transferred into the client records system prior to filling the form with the mapped set of data elements; and
receiving a transfer execution request from the user that comprises transfer mappings that map at least one of the set of data elements from the selected record of the service provider system to at least one of the fields of the form of the client record system; and
causing the at least one of the set of data elements from the selected record of the service provider system to be entered into at least one of the fields of the form of the client record system according to the transfer mappings.

2. The computer-implemented method of claim 1 wherein the selected record is of a third party.

3. The computer-implemented method of claim 1 wherein the information associated with a form that is used to enter data into the client records system and that is accessible via the browser comprises:
HyperText Markup Language (HTML) code for the form and a Uniform Resource Locator (URL) for the form.

4. The computer-implemented method of claim 3 wherein the information associated with a form that is used to enter data into the client records system further comprises:
at least some of the data elements in the form, the data elements in the form being obtained from a corresponding record in the client records system.

5. The computer-implemented method of claim 4 wherein the pre-fill user interface further comprises:
a display of a comparison of the at least one of the data elements in the form with at least one of the data elements from the service provider record, the comparison according to the mappings of the fields.

6. The computer-implemented method of claim 5 further comprising:
providing as part of the pre-fill user interface one or more interface inputs to receive input from a user indicating for each of a set of fields for the form whether to acceptance or rejection the data element from the selected record of the service provider system, thereby receiving mappings for the transfer mappings.

7. The computer-implemented method of claim 1 further comprising:
causing code to be executed to facilitate entering a data element into a field in the form.

8. The computer-implemented method of claim 1 further comprising:
for each of at least some of the fields in the form that received data elements as part of the transfer mappings, displaying a visual indicator that highlights the field.

9. A computer-implemented method for transferring data between different record systems, the method comprising:
receiving, from an application that operates in concert with a client system that comprises a plurality of records, a fill request to input data into one or more fields in a web form of the client system, the fill request comprising information specific to the web form of the client system and a record identifier that identifies a record from an accessible records system;
analyzing the information for the web form to obtain a mapping between at least some of the fields in the web form and at least some of the fields in the record from the accessible records system; and
responsive to obtaining a mapping, returning a response to the application, the response comprising:
a set of data elements from the record from the accessible records system, each data element having an associated field; and
fill instructions comprising the mapping.

10. The computer-implemented method of claim 9 further comprising:
providing the application to the client system as a browser extension or add-on.

11. The computer-implemented method of claim 9 further comprising:
responsive to not being able to obtain a mapping, returning a response indicating that a data transfer cannot be performed at that time.

12. The computer-implemented method of claim 9 further comprising:
receiving information for the record from the client system.

13. The computer-implemented method of claim 9 wherein:
the fill instructions further comprises code to be executed by the application in putting data into one or more fields in the web form.

14. The computer-implemented method of claim 13 wherein:
the code to be executed by the application further comprises selecting a value for a first field in the web form.

15. The computer-implemented method of claim 14 wherein:
a value for a second field in the web form is dependent upon the value of the first field and the code to be executed by the application further comprises instructions to wait until the web form has been updated following entry of the value in the first field before entering a value into the second field.

16. A non-transitory computer-readable medium or media comprising one or more sequences of instructions which, when executed by one or more processors, causes steps to perform the method of claim 9.

17. A computer-implemented method for providing a form with one or more associated images of a user who supplies data for the form, the method comprising:
receiving an image of the user and associated data comprising a unique identifier, the image being obtained from a client system comprising a form application that receives input from the user and that, responsive to the user triggering an event when interacting with the form application, causes an image to be taken of the user via a camera that is communicatively coupled to the client device;
storing the image of the user and its associated data comprising the unique identifier;
responsive to receiving the form data, which includes the unique identifier, for the user from the client system, using the unique identifier to find the image; and
adding the image to at least some of the form data to generate a combined file of the form data with the image.

18. The computer-implemented method of claim 17 wherein:
the combined file is a portable document format (PDF) file.

19. The computer-implemented method of claim 18 further comprising:
responsive to receiving the image and the associated data, sending a response to the client system that the image has been processed.

20. The computer-implemented method of claim 18 wherein the unique identifier is a session identifier and the associated data further comprises:
a tag, which is a description of the event that triggered the image to be captured.
